(19) United States
(12) Patent Application Publication
(10) Pub. No.: US 2012/0000018 A1
(43) Pub. Date: Jan. 5, 2012

(54) POSTURE CHANNEL SUPPORTS

(76) Inventors: David Michael Moret, Winston-Salem, NC (US); Larry K. DeMoss, Greensboro, NC (US); Brian M. Manuszak, Thomasville, NC (US); James A. Beamon, Jamestown, NC (US)

(21) Appl. No.: 12/960,735

(22) Filed: Dec. 6, 2010

Related U.S. Application Data
(63) Continuation of application No. 12/248,607, filed on Oct. 9, 2008, now Pat. No. 7,845,035.

(51) Int. Cl. A47C 23/04; F16F 3/00

(52) U.S. Cl. 5/716; 267/80

(57) ABSTRACT

A posture channel innerspring is described having a plurality of helical form coils interconnected in an array in which the coils are generally aligned in rows and columns, each of the coils having a generally cylindrical coil body formed by helical turns of wire with openings between each of the helical turns of wire, and first and second ends to the coil body also formed by the wire, each of the coil bodies being spaced apart in the array. At least one posture channel support is inserted into the innerspring in the space between the spaced apart coils. The posture channel support may, in one embodiment, have an H-shaped configuration with having upper and lower parallel lateral members and a transverse member that extends between and bisects the upper and lower lateral members. In another embodiment, the posture channel support may be substantially T-shaped having a lower lateral member, a vertical member which is perpendicular to and bisects the lower lateral member and a lateral extension which extends outward from one side of the vertical member. The posture channel inserts may be create or define zones or regions of the innerspring which have different support characteristics from other zones or regions. The posture channel inserts may also be placed around the border of the innerspring to provide increased stability in this area of a mattress assembly.

### RELATED APPLICATIONS

This application is a continuation of U.S. patent application Ser. No. 12/248,607 entitled “Pressure Dispersion Support System”, filed on Oct. 9, 2008, which is incorporated by reference herein in its entirety.

### FIELD OF THE INVENTION

The present invention is in the filed of reflexive support systems, springs and spring systems, including support systems for humans such as seating and bedding.

### BACKGROUND OF THE INVENTION

Different types of springs and spring systems are commonly used as the reflexive core of seating and support products such as chairs and mattresses. A common spring system which is used in mattresses and some upholstered furniture is the so-called “innerspring” which can be in one form a plurality of similarly or identically formed springs which are interconnected in an array or matrix. An innerspring provides a distributed generally homogeneous reflexive support system to give underlying support to an expanse such as the sleep surface of a mattress. The uniform spring rate across the expanse results from the common configuration of each of the interconnected springs. Attempts to alter the spring rate and feel of an entire innerspring or support area of an innerspring involve use of different types and amounts of materials such as foam, textiles and natural fibers as overlays on the innerspring. While the use of such materials does alter the feel and performance of the support system, it does not of course alter the spring rate of the underlying or internal innerspring.

Innersprings which are made of formed steel wire and are manufactured by wire forming machinery which forms the individual springs or coils, and then connects them together by smaller lacing wires or other fasteners. Once the machines are set up to make a particular spring or coil design and interconnection, large runs are made and it is difficult to change the form of the springs and innerspring. Therefore, with current innerspring production technology, it is not practical to produce a single innerspring which has variable or non-homogenous spring rates and support characteristics in different areas of the innerspring.

### SUMMARY OF THE INVENTION

In one embodiment, a posture channel innerspring is described as an innerspring formed by a plurality of springs connected together in an array wherein the springs are arranged in rows and columns, each spring having a body with a first end and a second end, the body of each spring being generally cylindrical and having a longitudinal axis and an outer diameter, the springs being spaced apart in the rows and columns and connected together in a spaced apart arrangement with each spring being spaced from each adjacent spring in the array. At least one posture channel insert is located in the innerspring in spaces between springs of the innerspring, the posture channel having an upper lateral member, a lower lateral member parallel and spaced apart from the upper lateral member and a transverse member which extends between and bisects the upper and lower lateral members, wherein the upper lateral member contains an arched upper surface and the lower lateral member contains an arched lower surface and wherein the upper and lower lateral members extend between and into the coils of two adjacent springs of the innerspring.

A second embodiment of the posture channel innerspring is described having a plurality of helical form coils interconnected in an array in which the coils are generally aligned in rows and columns, each of the coils having a generally cylindrical coil body formed by helical turns of wire with openings between each of the helical turns of wire, and first and second ends to the coil body also formed by the wire, each of the coil bodies being spaced apart in the array. At least one posture channel insert is located between and engaged with two or more of the coils of the innerspring, the at least one posture channel insert having a lower lateral member, a vertical member which is perpendicular to and bisects the lower lateral member and a lateral extension which extends outward from one side of the vertical member. The lower lateral member extends between and into the body of two adjacent coils of the innerspring, the lateral extension extends into the body of one of the two adjacent coils and the vertical member is in contact with the two adjacent coils.

### DESCRIPTION OF THE DRAWINGS

FIG. 1 is a perspective view of a first embodiment of the posture channel supports of the present invention.

FIG. 2 is a perspective view of an innerspring with posture channel support of FIG. 1.

FIG. 3 is a perspective view of an innerspring coil used with the posture channel support of FIG. 1.

FIG. 4 is a partial side elevation of the innerspring of FIG. 2.

FIG. 5 is a partial end elevation of the innerspring of FIG. 2.

FIG. 6 is a plan view of a representative innerspring with posture channel support of FIG. 1.

FIG. 7 is a perspective view of a second embodiment of the posture channel supports of the present invention.

FIG. 8 is a perspective view of an innerspring with posture channel support of FIG. 7.

FIG. 9 is a perspective view of an innerspring coil used with the posture channel support of FIG. 7.

FIG. 10 is a partial side elevation of the innerspring of FIG. 8.

FIG. 11 is a plan view of representative innerspring with posture channel support of FIG. 7.

### DETAILED DESCRIPTION OF PREFERRED AND ALTERNATE EMBODIMENTS

As shown in the drawings, an innerspring generally referenced at 11, has a plurality of springs or coils (herein referred to alternatively as “coils” or “springs”), although the disclosure and invention is not limited to any one particular type or form of spring or coil or other reflexive device. The coils are arranged in an array, such as an orthogonal array of columns and rows and interconnected by lacing wires which in one form are helical wires which are laced about turns of adjacent coils and typically run transverse across a width of the innerspring, but which can be run in other directions. The lacing wires can be located at either or both ends of the coils. Coil ends are formed at opposite axial ends of the coil body and aligned in the opposing (upper and lower) planes of the innerspring as described. The coil ends are aligned in planes which define support surfaces of the innerspring. In many innersprings of this type, there is open space between the adjacent coil bodies, necessary to allow flexure, compression and deflection of the coils and relative movement without inter-coil contact.

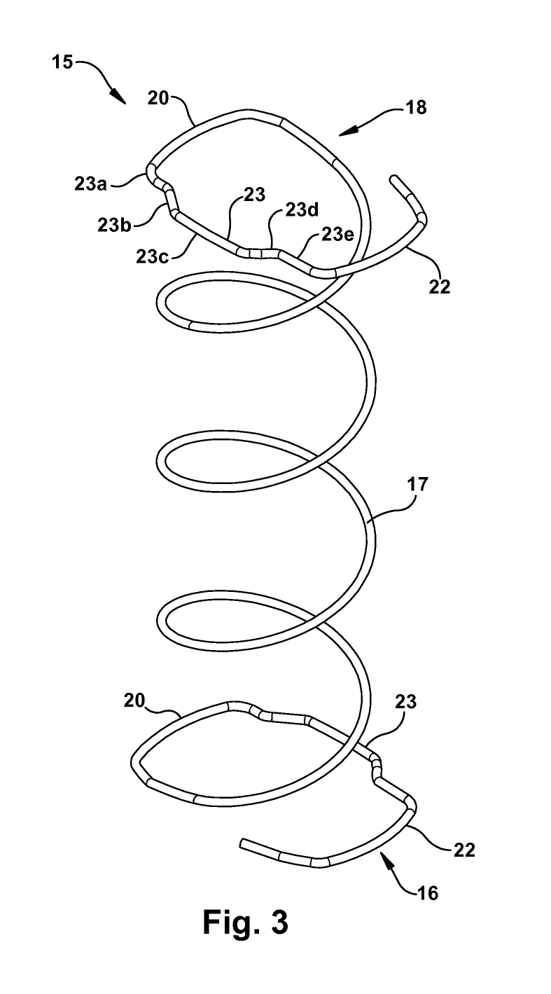

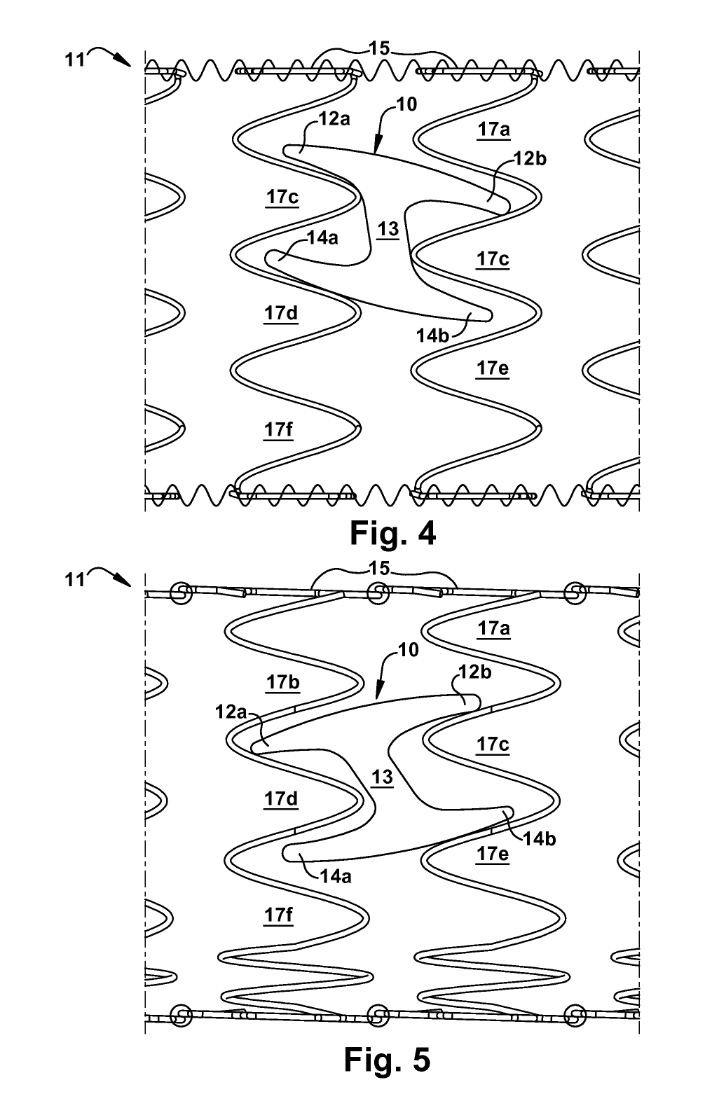

In a first embodiment of the present invention, the coils of the mattress innerspring shown are rotated coil head coils (herein after referred to as “RCH coils”) 15, which have a generally cylindrical body 17 formed by a plurality of helical turns, as shown in FIG. 3. The coil ends 16, 18 each have an offset and the opposing coil ends are inverted relative to each other so that they terminate on the same side of the coil body 17. The rotated coil head prevents the coil from leaning in a lateral direction when a downwardly directed load is applied to the innerspring. The generally cylindrical coil body 17 has a longitudinal axis which runs the length of the coil at the radial center of each of the helical turns of the coil 15. The coil body 17 is contiguous with the first coil end, generally indicated at 16 and a second coil end, generally indicated at 18. The designations “first coil end” and “second coil end’ are for identification and reference only and do not otherwise define the locations or orientations of the coil ends. Accordingly, either the first coil end 16 or the second coil end 18 may alternatively be referred to herein as “coil end”. Either of the coil ends 16, 18 may serve as the support end of the coil 15 in an innerspring in a one or two-sided mattress. Each of the coil ends 16, 18 lie generally in respective planes generally perpendicular to the longitudinal axis of the coil body 17. The coil ends 16, 18 are identical in form and have a larger diameter than the coil body 17. The coil ends 16, 18 are each formed in an open end offset configuration comprised of three offset portions and an open end. The overall shape of the coil ends 16, 18 is rectangular. Offset portions 20 and 22 have generally straight segments which are roughly parallel to each other. The third offset portion 23 extends between ends of the first 20 and second 22 offset portions and has a stepped segment of multiple contiguous segments 23a-23e. Coil ends which have one or more linear segments, such as in coil ends 16 and 18, are advantageous for allowing the coils to be more closely spaced in an innerspring array than coils with circular ends, and by providing a linear path for lacing wires that run between coils. The coils are positioned such that the offset portions of the adjacent coils in a row overlap. The overlapped offset pairs are then secured together by spirally rotating a first set of helical coil springs across the rows so as to interlace the overlapped offset portions. Since the coils are generally helical in form, the turns of each coil are laterally aligned and together form a wave-form or serpentine spaces or openings between each coil and between the rows and columns of coils in the innerspring. The spaces or openings 17 extend into the respective coil bodies. For example, as shown in FIGS. 4 and 5, the openings have different zones or areas or regions indicated at 17a, 17b, 17c, 17d, 17e and 17f (also referred to herein as “opening regions” or “spaces”) defined by the helical turns of the opposing coils. The opening regions 17a-17f extend into the respective coil bodies. The number of openings will vary according to the number of helical turns of the coil body.

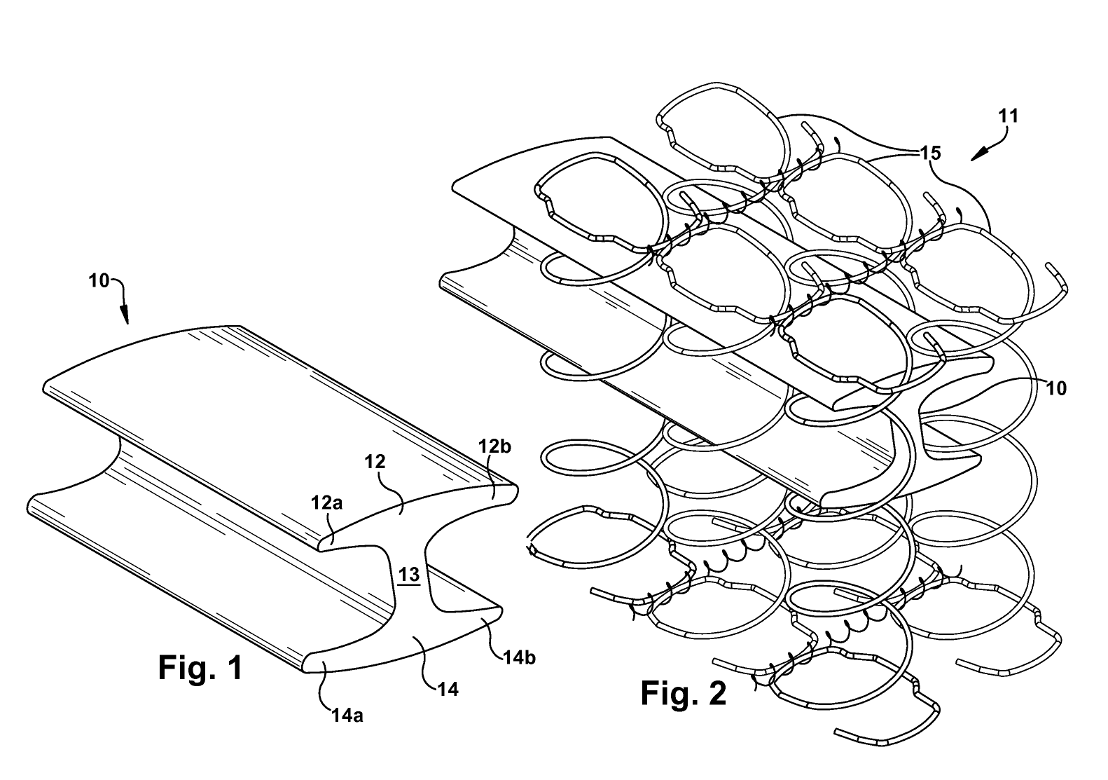

An H-shaped posture channel 10 is used in combination with an RCH coil innerspring as described above and as shown in FIGS. 1 and 2. The posture channel 10 contains upper 12 and lower 14 parallel lateral members and a transverse member 13 that extends between and bisects the upper 12 and lower 14 lateral members. The upper and lower parallel lateral members 12, 14 each include two segments 12a, 12b, 14a, 14b which fit between the coils of an innerspring, in the gaps or openings 17 formed between spaced apart coils. The posture channels 10 are configured to fit within at least two or more openings 17 in order to engage with and maintain alignment with the coils. Each posture channel 10 contains two upper segments 12a, 12b which extend from the lateral member 12 in opposing first and second directions and two lower segments 14a, 14b which extend from the lateral member 14 in opposing first and second directions. Each posture channel 10 has a unique slanted or angled configuration that enables the lateral segments to extend into and fit securely within the opening region between two adjacent coils or rows of adjacent coils without the use of an attachment mechanism. In a preferred embodiment, each of the transverse parallel members is approximately between 90.5 and 94.2 mm wide. The transverse member 13 that extends between and bisects the two transverse parallel members 12, 14 is approximately between 15.5 and 18.5 mm wide. The height of the entire pasture channel 10 is approximately between 57 and 60 mm.

One representative cross-sectional form of an H-shaped posture channel insert 10 of the disclosure is shown in FIG. 4. Here, the posture channel insert is positioned within the space between adjacent coils in a lengthwise direction. Section 12a of the posture channel support fits within opening 17a of a first coil while section 12b is positioned within opening 17b of a second coil. Also, section 14a is located within opening 17c of the first coil while section 14b is located within opening 17d of the second coil. Another example of a cross-sectional form of the H-shaped posture channel insert 10 is shown in FIG. 5. In this example, the posture channel insert is positioned within the space between adjacent coils in a widthwise direction. Section 12a of the posture channel insert is positioned within opening 17e of a first coil and section 12b is positioned within opening 17b of a second coil. Section 14a is positioned within opening lie of the first coil and section 14b is positioned within opening 17d of the second coil.

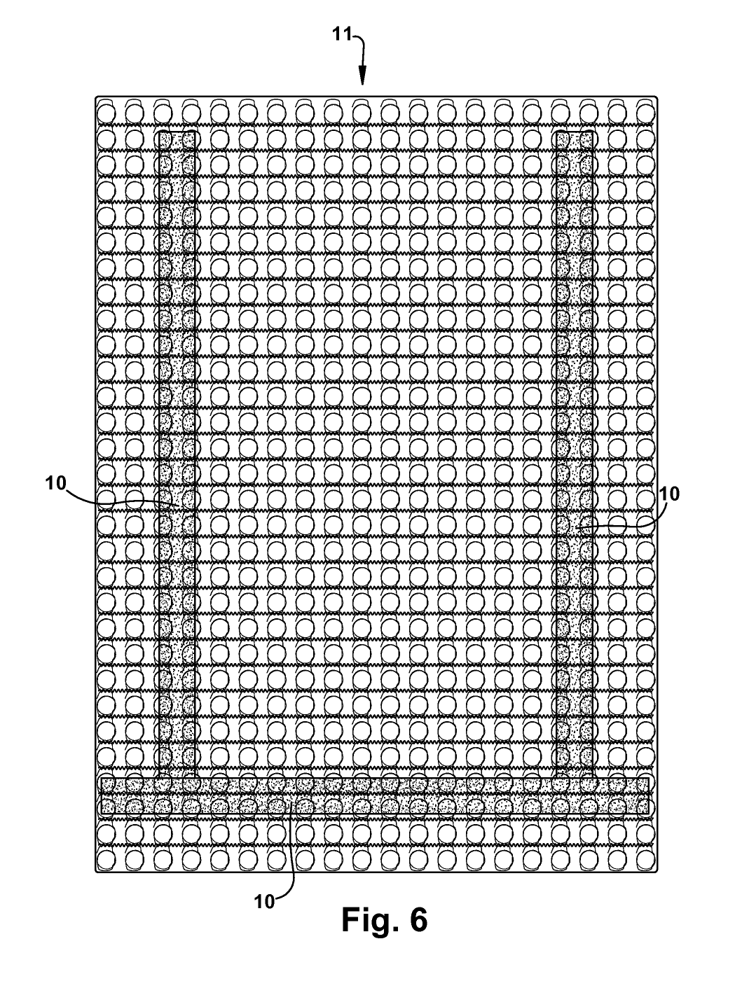

As shown in FIG. 6, different lengths of posture support channels 10 are arranged in a generally U-shaped configuration proximate to the right and left side edges and the bottom edge of the innerspring. This arrangement provides increased stability in the border region of the mattress. Two H-shaped posture channel supports are positioned in a longitudinal direction parallel to one another, with one H-shaped posture channel positioned in a transverse direction extending between and perpendicular to the two longitudinally placed posture channels. Each section of piece of the posture channels can be closely abutted with an intersection section or piece, or a space left therebetween. The number, size and location of the posture channel inserts can also create or define zones or regions of the innerspring which have different support characteristics from other zones or regions. These can accordingly be placed or designed for particular mattress application, such as creating increased support and/or pressure-reducing areas or zones in cooperation with overlying layers of material such as foam padding layers, woven and non-woven material layers and upholstery including padded upholstery. The length of the posture channels used for the edge supporting U-shaped configuration shown in FIG. 6 is dependent upon the size of the mattress. The approximate length of each posture channel is shown in the following table with respect to the various standard mattress sizes:

| | Number | Number | Number |
|---|---|---|---|
| | of | of | of |
| | 57.25″ H- | 50″ H- | 35″ H- |
| | shaped | shaped | shaped |
| | posture | posture | posture |
| | channels | channels | channels |
| | used | used | used |
| Twin | 2 | 0 | 1 |
| Twin XL | 2 | 0 | 1 |
| Full | 2 | 1 | 0 |
| Full XL | 2 | 1 | 0 |
| Queen | 3 | 0 | 0 |
| King | 2 | 0 | 2 |
| Cal King | 2 | 0 | 2 |

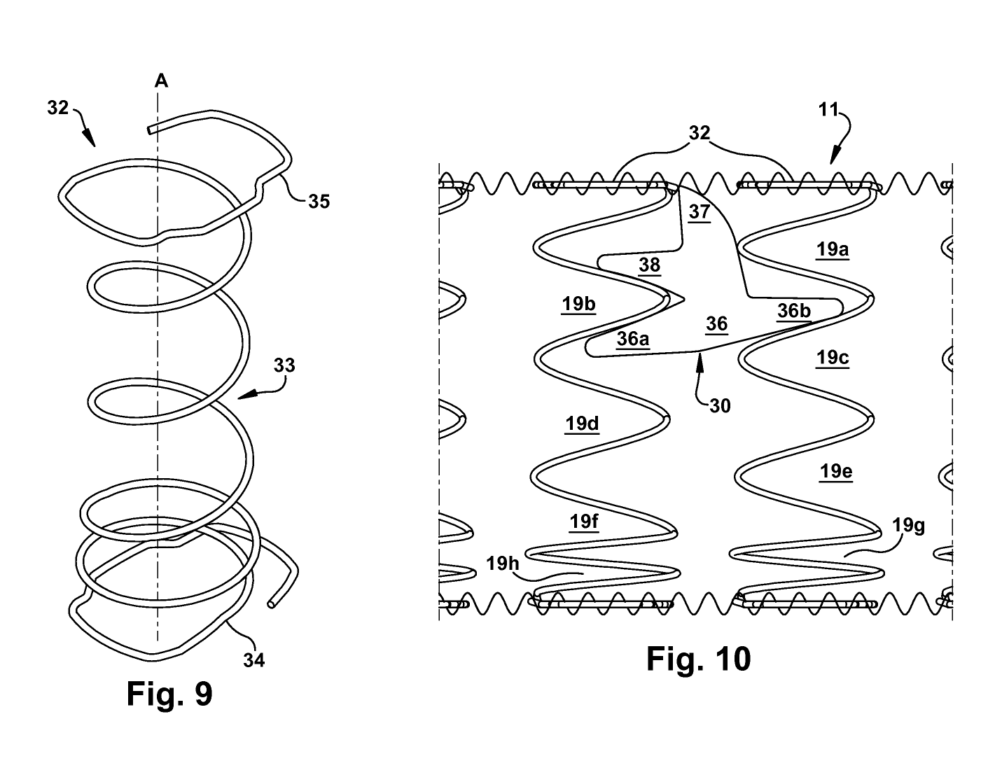

In a second embodiment of the present invention, the coils of the mattress innerspring shown in FIGS. 8 and 9, are two-tiered RCH coils 32. The only difference between the RCH coil 15 as described above, and the two-tiered RCH coil 32 is that the two-tiered coil is asymmetrical about both a horizontal and vertical plane. The term asymmetric, as used herein, refers to the configuration of the coil on one side of a reference plane, such as a vertical reference plane passing through a vertical axis A of the coil body 33, or a horizontal reference plane passing perpendicularly through the axis A is different on one side of the plane than on the other. The coils 32 have a generally helical form coil body 33 which extends between a base or bottom end 34 and a top or support end 35. The base 34 and top 35 of the coil may also be referred to as the terminal convolutions. The portion of the coil body 33 on the side of the reference plane HP proximate to the top or support end is also referred to as the upper region of the coil body. The portion of the coil body 33 on the side of the reference plane HP proximate to the base or bottom end is also referred to as the lower region. As is known in the art, the primary factors which determine the spring rate and resultant feel of a spring are wire gauge, the size (diameter) and the pitch (or pitch angle) of the helical turns of the coil. In generally, the more turns to the coil the lower the spring rate, with a resultant softer feel and support. Larger diameter turns in a coil also contribute to a lower spring rate and consequent softer feel. The greater or steeper the pitch, the stiffer the spring is, due to increased vertical orientation of the wire. As can be seen in FIGS. 9 and 10, the pitch angle between the turns or convolutions in the lower region of the coil is much smaller than the pitch angle between the turns or convolutions in the upper region of the coil, providing a relatively stiff lower region. The pitch gradually increases toward the top of the coil, which lessens the spring rate toward and upper region of the coil body, treating a softer feel or support to the spring, at least upon initial compression. The diameter of each of the turns is identical except for the second turn from the base of the coil, which happens to have the largest diameter of the coil body. An increasing diameter generally increases the spring rate to a stiffer feel, which again, combined with the lower pitch angles, give the lower region of the coil body a stiffer, more supportive feel than the upper region of the coil.

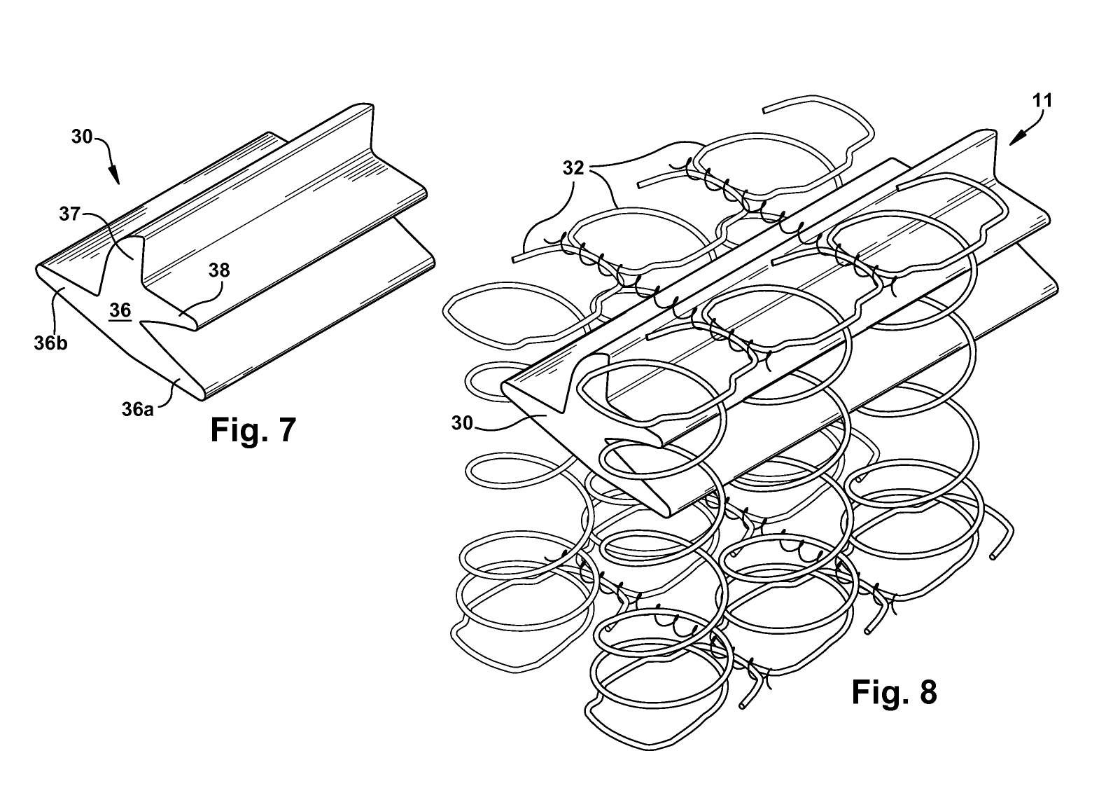

A generally T-shaped posture channel 30, shown in FIGS. 7 and 8 is used in combination with a two-tiered RCH coil innerspring, as described above. The generally T-shaped posture channel 30 contains a lower lateral member 36 and a vertical member 37 which is perpendicular to and bisects the lower lateral member 36. The vertical member 37 additionally contains a lateral extension 38 which extends outward from one side of the vertical member 37. The lower lateral member 36 contains a right portion 36a and a left portion 36b. These posture channels 30 are uniquely designed to fit between the spaces or openings between two two-tired RCH coils 32 located in adjacent rows of the innerspring. A first portion of the lower lateral member 36a and the lateral extension 38 of the vertical member 37 fit between two adjacent coils of the same spring. A second portion of the lower lateral member 36b extends into the turns of a coil located in an adjacent row of the innerspring. In a preferred embodiment, the generally T-shaped posture channel 30 is between approximately 72.5 and 77.5 mm wide and approximately between 44.5 and 49.5 mm high. The width of the vertical member, at its largest point, is approximately between 18.5 and 21.5 mm and the height from the lower lateral member to the top of the lateral extension is approximately between 26.5 and 29.5 mm.

A representative cress-sectional form of the T-shaped posture channel insert 30 of the disclosure is shown in FIG. 10. The spaces or openings between two adjacent two-tier RCH coils, referred to as openings 19a-19h, accommodate the various sections of the T-shaped posture channels. For example, the right portion 36a of the lower lateral member 36 is positioned within opening 19c of a first coil and the left portion 361) is positioned within opening 19b of a second coil. The lateral extension 38 is positioned within opening 19a of the first coil. Vertical member 37 is in contact with both the first and second coils.

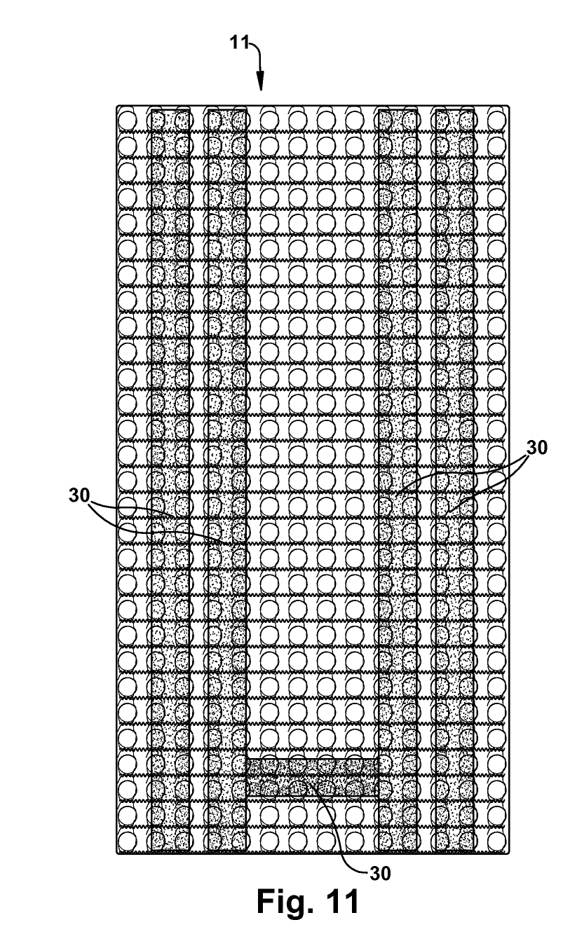

As shown in FIG. 11, a plurality of generally T-Shaped posture channels 30 are positioned along two rows proximate to and running along the length of the right side of the innerspring, along two rows proximate to and running along the length of the left side of the innerspring, and along one horizontal row proximate to the foot of a mattress and extending substantially between the two right side and two left side rows of posture channels. The following chart shows the various sized T-shaped channels used for different mattress sizes:

| | Number | Number | Number | Number | Number | Number |
|---|---|---|---|---|---|---|
| | of | of | of | of | of | of |
| | 76.0″ T- | 71.0″ T- | 45.0″ T- | 33.0″ T- | 25.0″ T- | 10.75″ T- |
| | shaped | shaped | shaped | shaped | shaped | shaped |
| | posture | posture | posture | posture | posture | posture |
| | channels | channels | channels | channels | channels | channels |
| | used | used | used | used | used | used |
| Twin | 0 | 4 | 0 | 0 | 0 | 1 |
| Twin XL | 4 | 0 | 0 | 0 | 0 | 1 |
| Full | 0 | 4 | 0 | 0 | 1 | 0 |
| Full XL | 4 | 0 | 0 | 0 | 1 | 0 |
| Queen | 4 | 0 | 0 | 1 | 0 | 0 |
| King | 4 | 0 | 1 | 0 | 0 | 0 |
| Cal King | 4 | 0 | 1 | 0 | 0 | 0 |

In a preferred embodiment, both the H-shaped and T-shaped posture channels described above are made of 100% low density polyethylene with a density of approximately 1.25 lb/ft³, although other materials and densities are considered to be within the scope of the invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A posture channel innerspring comprising:
an innerspring formed by a plurality of springs connected together in an array wherein the springs are arranged in rows and columns, each spring having a body with a first end and a second end, the body of each spring being generally cylindrical and having a longitudinal axis and an outer diameter, the springs being spaced apart in the rows and columns and connected together in a spaced apart arrangement with each spring being spaced from each adjacent spring in the array;
at least one posture channel insert located in the innerspring in spaces between springs of the innerspring, the posture channel haying an upper lateral member, a lower lateral member parallel and spaced apart from the upper lateral member and a transverse member which extends between and bisects the upper and lower lateral members;
wherein the upper lateral member contains an arched upper surface and the lower lateral member contains an arched lower surface; and
wherein the upper and lower lateral members extend between and into the coils of two adjacent springs of the innerspring.

2. The posture channel innerspring of claim 1, wherein the at least one posture channel insert is positioned within the spaces between springs of the innerspring in a slanted orientation.

3. The posture channel innerspring of claim 1, wherein the plurality of springs are RCH springs.

4. The posture channel innerspring of claim 1, wherein the height of the at least one posture channel insert is approximately between 57 and 60 mm.

5. The posture channel innerspring of claim 1, wherein the width of the at least one posture channel insert is approximately between 90.5 and 94.2 mm.

6. The posture channel innerspring of claim 1, wherein three posture channels are configured in a U-shaped arrangement.

7. The posture channel innerspring of claim 1, wherein there is a first posture channel is positioned along the length of a first side of the innerspring, a second posture channel is positioned parallel to the first posture channel and along the length of a second side of the innerspring and a third posture channel is positioned perpendicular to both the first and second posture channels along the width of a third side of the innerspring.

8. The posture channel innerspring of claim 7, wherein the first and second posture channels are approximately 57.25 inches long and the third posture channel is approximately between 35 and 57.25 inches long.

9. The posture channel innerspring of claim 1 having at least two posture channel inserts positioned parallel to each other within the innerspring.

10. The posture channel innerspring of claim 9, wherein the at least two posture channels are positioned proximate to opposing edges of the innerspring.

11. The posture channel innerspring of claim 7, wherein the first, second and third posture channels are positioned proximate to three edges of the innerspring.

12. A posture channel innerspring comprising:
a plurality of helical form coils interconnected in an array in which the coils are generally aligned in rows and columns, each of the coils having a generally cylindrical coil body formed by helical turns of wire with openings between each of the helical turns of wire, and first and second ends to the coil body also formed by the wire, each of the coil bodies being spaced apart in the array;
at least one posture channel insert located between and engaged with two or more of the coils of the innerspring, the at least one posture channel insert having a lower lateral member, a vertical member which is perpendicular to and bisects the lower lateral member and a lateral extension which extends outward from one side of the vertical member;
wherein the lower lateral member extends between and into the body of two adjacent coils in the innerspring, the lateral extension extends into the body of one of the two adjacent coils, and the vertical member is in contact with the two adjacent coils.

13. The posture channel innerspring of claim 12, wherein the plurality of helical form coils are two-tier RCH coils.

14. The posture channel innerspring of claim 12, wherein the plurality of helical form coils are asymmetrical.

15. The posture channel innerspring of claim 12, wherein the at least one posture channel insert is approximately between 72.5 and 77.5 mm wide.

16. The posture channel innerspring of claim 12, wherein the at least one posture channel insert is approximately between 44.5 and 49.5 mm in length.

17. The posture channel innerspring of claim 12, wherein the at least one posture channel insert is made of polyethylene.

18. The posture channel innerspring of claim 12, wherein the at least one posture channel insert has a density of approximately 1.25 lb/ft³.

19. The posture channel innerspring of claim 12, wherein there are at least two posture channel inserts that are positioned parallel to each other within the innerspring.

20. The posture channel innerspring of claim 12, wherein there are at least three posture channel inserts that are positioned in a u-shaped configuration within the innerspring.
